(19) United States
(12) Patent Application Publication
(10) Pub. No.: US 2009/0317722 A1
(43) Pub. Date: Dec. 24, 2009

(54) NEGATIVE ELECTRODE MATERIAL, NON-AQUEOUS ELECTROLYTE SECONDARY BATTERY, AND ELECTROCHEMICAL CAPACITOR

(76) Inventor: Koichiro WATANABE, Annaka-shi (JP)

Correspondence Address: BIRCH STEWART KOLASCH & BIRCH, PO BOX 747, FALLS CHURCH, VA, 22040-0747, US

(21) Appl. No.: 12/486,233

(22) Filed: Jun. 17, 2009

(30) Foreign Application Priority Data
Jun. 23, 2008 (JP) 2008-162973

(51) Int. Cl. H01M 4/58; H01G 9/042

(52) U.S. Cl. 429/231.95; 429/218.1; 361/516; 361/504

(57) ABSTRACT

Silicon particles are irradiated with neutrons so that ³⁰Si of silicon isotopes is transformed to ³¹P through nuclear reaction. A negative electrode material comprising the P-doped silicon powder exhibits good cycle performance of silicon and is endowed with a high conductivity while maintaining the high initial efficiency and high battery capacity of silicon, and is thus useful as an active material in a negative electrode of a non-aqueous electrolyte secondary battery.

### CROSS-REFERENCE TO RELATED APPLICATION

This non-provisional application claims priority under 35 U.S.C. §119(a) on Patent Application No. 2008-162973 filed in Japan on Jun. 23, 2008, the entire contents of which are hereby incorporated by reference.

### TECHNICAL FIELD

This invention generally relates to non-aqueous electrolyte secondary batteries, typically lithium ion secondary batteries, and electrochemical capacitors. Specifically, it relates to negative electrode materials for use in such batteries which provide lithium ion secondary batteries with a high charge/discharge capacity and improved cycle performance.

### BACKGROUND ART

In conjunction with the recent rapid advances of portable electronic equipment and communications instruments, non-aqueous electrolyte secondary batteries having a high energy density are strongly demanded from the aspects of cost, size and weight reductions. A number of measures are known in the art for increasing the capacity of such non-aqueous electrolyte secondary batteries. For example, JP 3008228 and JP 3242751 disclose negative electrode materials comprising oxides of B, Ti, V, Mn, Co, Fe, Ni, Cr, Nb, and Mo and composite oxides thereof. A negative electrode material comprising M₁₀₀₋ₓSiₓ wherein x≧50 at % and M=Ni, Fe, Co or Mn is obtained by quenching from the melt (JP 3846661). Other negative electrode materials are known as comprising silicon oxide (JP 2997741), and Si2N₂O, Ge₂N₂O or Sn₂N₂O (JP 3918311).

Silicon is regarded most promising in attaining the battery's goals of size reduction and capacity enhancement since it exhibits an extraordinarily high theoretical capacity of 4,200 mAh/g as compared with the theoretical capacity 372 mAh/g of carbonaceous materials that are currently used in commercial batteries. Silicon is known to take various forms of different crystalline structure depending on their preparation. For example, JP 2964732 discloses a lithium ion secondary battery using single crystal silicon as a support for negative electrode active material. JP 3079343 discloses a lithium ion secondary battery using a lithium alloy LiₓSi (0≦x≦5) with single crystal silicon, polycrystalline silicon or amorphous silicon. Of these, the lithium alloy LiₓSi with amorphous silicon is preferred, which is prepared by coating crystalline silicon with amorphous silicon resulting from plasma decomposition of monosilane, followed by grinding. However, the negative electrode material therein uses 30 parts of a silicon component and 55 parts of graphite as the conductive agent as described in Example, failing to take full advantage of the battery capacity of silicon.

One appropriate approach for improving cycle performance by mitigating volume expansion is the use of polycrystalline silicon as disclosed in JP-A 2003-109590. However, polycrystalline silicon has a low conductivity due to a minimal impurity content and is thus inferior in rate characteristics to metallic silicon. There is a need to impart conductivity to polysilicon.

For the purpose of imparting conductivity to negative electrode materials, JP-A 2000-243396 teaches mechanical alloying of a metal oxide such as silicon oxide with graphite and subsequent carbonization; JP-A 2000-215887 mentions coating of Si particles on their surface with a carbon layer by chemical vapor deposition; and JP-A 2002-42806 proposes coating of silicon oxide particles on their surface with a carbon layer by chemical vapor deposition. The provision of particle surfaces with a carbon layer improves conductivity, but has the problem that the bond of carbon coating to silicon surface is adversely affected by volume expansion of polycrystalline silicon so that the cycle performance is acceleratedly deteriorated. It is thus needed to improve the conductivity of polycrystalline silicon itself.

Polycrystalline silicon can be improved in conductivity by incorporating a dopant such as phosphorus or boron. Such doping may be implemented by heat diffusion, laser doping, plasma doping or ion implantation as described in JP-A 2003-109590. Since the dopant is incorporated into only a subsurface region of particles, it is difficult to reduce the bulk resistance.

Citation List

Patent Document 1: JP 3008228

Patent Document 2: JP 3242751

Patent Document 3: JP 3846661

Patent Document 4: JP 2997741

Patent Document 5: JP 3918311

Patent Document 6: JP 2964732

Patent Document 7: JP 3079343

Patent Document 8: JP-A 2003-109590

Patent Document 9: JP-A 2000-243396

Patent Document 10: JP-A 2000-215887

Patent Document 11: JP-A 2002-042806

### SUMMARY OF INVENTION

An object of the invention is to provide a negative electrode material which is effective as an active material in a negative electrode of a non-aqueous electrolyte secondary battery in that it exhibits good cycle performance characteristic of silicon, especially polycrystalline silicon, and is endowed with a high conductivity while maintaining the high initial efficiency and high battery capacity of silicon. Another object is to provide a negative electrode made of this material, and a non-aqueous electrolyte secondary battery and an electrochemical capacitor using the same.

Making efforts to search for a silicon active material whose battery capacity per volume surpasses the standard capacity of 844 mAh/cc for carbonaceous materials and the potential capacity of 1,500 mAh/cc expected for silicon alloy based negative electrode active materials proposed thus far, the inventor has found that silicon particles are improved in conductivity by irradiating silicon particles, specifically polycrystalline silicon particles having grain boundaries, with neutrons so that the particles are uniformly doped with phosphorus. A negative electrode material comprising the P-doped silicon particles as an active material solves the outstanding problems. A negative electrode formed by combining the negative electrode material with a binder such as polyimide resin is resistant to failure and powdering by repetitive expansion and contraction during charge/discharge cycles, so that the electrode itself may keep conductivity unchanged. Using this negative electrode material, a non-aqueous electrolyte secondary battery having improved cycle performance can be fabricated. The invention is predicated on this finding.

According to the invention, there is provided a negative electrode material for non-aqueous electrolyte secondary batteries, comprising silicon particles wherein ³⁰Si in silicon has been transformed to ³¹P through nuclear reaction by neutron irradiation.

Preferably, the silicon is polycrystalline silicon. The silicon particles preferably contain 1 to 100,000 ppm of phosphorus. A powder of the silicon particles preferably has a resistivity of up to 100 kΩ-cm. In a preferred embodiment, the negative electrode material comprises 60 to 97% by weight of polycrystalline silicon particles, 3 to 20% by weight of a binder, and 0 to 37% by weight of a conductive agent.

In another aspect, the invention provides a negative electrode for non-aqueous electrolyte secondary batteries, comprising the negative electrode material defined above.

In a further aspect, the invention provides a non-aqueous electrolyte secondary battery comprising a negative electrode shaped form comprising the negative electrode of the other aspect, a positive electrode shaped form, a separator, and a non-aqueous electrolyte. It is typically a lithium ion secondary battery.

In a still further aspect, the invention provides an electrochemical capacitor comprising a negative electrode shaped form comprising the negative electrode of the other aspect, a positive electrode shaped form, a separator, and a non-aqueous electrolyte.

### ADVANTAGEOUS EFFECTS OF INVENTION

When used in non-aqueous electrolyte secondary batteries, the negative electrode material of the invention exhibits good cycle performance and rate characteristics while maintaining the high initial efficiency and high battery capacity of silicon. The negative electrode material comprising neutron-irradiated silicon particles, specifically polycrystalline silicon particles as an active material and a binder is fully adherent to a current collector. The non-aqueous electrolyte secondary battery has a high initial efficiency and maintains improved performance and efficiency over repeated charge/discharge cycles by virtue of mitigated volume changes during charge/discharge cycles.

### DESCRIPTION OF EMBODIMENTS

As used herein, the term “conductive” or “conductivity” refers to electrically conductive or electric conductivity.

The negative electrode material for non-aqueous electrolyte secondary batteries according to the invention comprises particles of silicon, specifically polycrystalline silicon, wherein ³⁰Si of silicon isotopes has been transformed to ³¹P through nuclear reaction by neutron irradiation.

As is well known in the art, silicon is divided into single crystal silicon, polycrystalline silicon, and amorphous silicon in terms of crystallinity, and into chemical grade silicon (often referred to as metallic silicon) and metallurgical grade silicon in terms of purity. Polycrystalline silicon consists of partially ordered crystals. Amorphous silicon differs in that it assumes a substantially disordered arrangement of silicon atoms having a network structure, but amorphous silicon can be transformed into polycrystalline silicon by heat aging. Polycrystalline silicon consists of relatively large crystal grains of different orientation defining boundaries therebetween. As described in Complete Series of Inorganic Chemistry, Vol. XII-2, Silicon (Maruzen Co., Ltd.), p184, polycrystalline silicon can be synthesized from trichlorosilane or monosilane. The current mainstream processes for producing polycrystalline silicon in an industrial manner are the Siemens process and Komatsu-ASiMI process involving pyrolysis of trichlorosilane or monosilane in a precipitating reactor (or bell Jar) and depositing in a silicon rod form. The Ethyl Corporation process involving using a fluidized bed reactor and growing polycrystalline silicon on surfaces of silicon particles is also available. Polycrystalline silicon may also be prepared by melting metallic silicon and directionally solidifying the melt, for thereby causing segregation of impurities and increasing the purity, or by quenching the silicon melt. It is known that polycrystalline silicon products thus synthesized differ in conductivity and residual strain depending on the size and orientation of crystal grains.

The silicon used herein is preferably polycrystalline silicon, inter alia, polycrystalline silicon which is produced through pyrolysis of silane gas or chlorosilane and crystal growth. Excluded are polycrystalline silicon products produced by directional solidification and vapor phase quenching and products obtained by hot plastic working of silicon ingots. When polycrystalline silicon is produced through pyrolysis of silane gas or chlorosilane and crystal growth, fine voids form among crystal grains of polycrystalline silicon being deposited. These fine voids serve to mitigate volume expansion upon charging, thus inhibiting fissure.

The polycrystalline silicon thus produced is ground to the desired particle size prior to use. Note that the particle size is a weight average value D₅₀ which is a 50% cumulative weight diameter or median diameter on particle size distribution measurement by laser diffraction scattering method. The silicon powder should preferably have a median diameter D₅₀ of 0.1 μm to 50 μm and more preferably 0.5 μm to 20 μm. Too small an average particle size corresponds to too large a specific surface area so that the negative electrode film density may become lower. Particles with too large a particle size may protrude from a negative electrode film, causing short-circuits.

To produce polycrystalline silicon particles of the predetermined size, any well-known grinding machine may be used in combination with a classifier. Use may be made of, for example, a ball mill and media agitating mill in which grinding media such as balls or beads are brought in motion and the charge (to be ground) is ground by utilizing impact forces, friction forces or compression forces generated by the kinetic energy; a roller mill in which grinding is carried out by compression forces generated between rollers; a jet mill in which the charge is impinged against the liner or each other at a high speed, and grinding is carried out by impact forces generated by impingement; a hammer mill, pin mill and disc mill in which a rotor with hammers, blades or pins attached thereto is rotated and the charge is ground by impact forces generated by rotation; a colloid mill utilizing shear forces; and a wet, high pressure; counter-impingement dispersing machine “Ultimizer” (Sugino Machine Ltd.). Either wet or dry grinding may be employed. The grinding may be followed by dry, wet or sieve classification in order to gain a proper particle size distribution. The dry classification generally uses a gas stream and includes successive or simultaneous steps of dispersion, separation (segregation between fine and coarse particles), collection (separation between solid and gas), and discharge. To prevent the classification efficiency from being reduced by the impacts of interference between particles, particle shape, turbulence and velocity distribution of the gas stream, electrostatic charges, or the like, pretreatment (adjustment of water content, dispersibility, humidity or the like) is carried out prior to the classification, or the gas stream is adjusted in moisture content and oxygen concentration prior to use. An integrated type of dry grinder/classifier may also be used which can conduct grinding and classifying operations at a time to deliver an output of the desired particle size distribution.

The polycrystalline silicon powder thus obtained is irradiated with neutrons so that it is doped with phosphorus. Neutron irradiation may be performed either prior to or subsequent to grinding. For neutron irradiation, usually a quartz tube is filled with the silicon and placed in a special capsule for irradiation. If the irradiation time is short, a polyethylene bag or the like may be used. While the amount of phosphorus (P) doped depends on the thermal neutron flux of the irradiation system and the irradiation time, the silicon powder is preferably doped with 1 to 100,000 ppm of phosphorus, more preferably 10 to 10,000 ppm of phosphorus. To small content of phosphorus may provide less conductivity whereas more than 100,000 ppm of phosphorus may bring about a noticeable decline of capacity.

Preferred neutron irradiation conditions include a thermal neutron flux of 1.0×10¹⁶ to 1.0×10²⁰/m²-s, especially 1.0×10¹⁷ to 1.0×10⁹/m²-s, and an irradiation time of 0.5 to 20 hours, more preferably 0.5 to 10 hours, and even more preferably 1 to 10 hours. Removal from the tube is permissible after 2.5 hours which is the half life of silicon.

The polycrystalline silicon powder thus treated should preferably have a resistivity of up to 100 kΩ-cm, more preferably up to 50 kΩ-cm, as measured by the AC impedance method. A powder having a resistivity in excess of the limit may form an electrode with a higher resistance, which may lead to poor initial characteristics of a battery.

According to the invention, the polycrystalline silicon powder thus treated is used as the active material for non-aqueous electrolyte secondary battery negative electrodes. The powder has many advantages including a high capacity as compared with the currently used graphite and carbonaceous materials, a high initial efficiency as compared with silicon oxide and silicon oxide-derived materials (e.g., silicon/silicon dioxide dispersed composite resulting from disproportionation of silicon oxide), controlled volume changes associated with charge/discharge cycles as compared with silicon itself, and improved adhesion between particles and the binder. This ensures fabrication of a non-aqueous electrolyte secondary battery, especially lithium ion secondary battery, having improved cycle performance.

A negative electrode is prepared using a negative electrode material comprising polycrystalline silicon particles as the active material. At this point, a binder is used in the negative electrode material. The binder is preferably selected from polyimide resins, especially aromatic polyimide resins. The aromatic polyimide resin binder has good solvent resistance, and may comply with a volume expansion associated with charge/discharge cycles to prevent peeling of the negative electrode from the current collector and separation of the active material.

The aromatic polyimide resins are generally difficultly soluble in organic solvents and must not be swollen or dissolved in electrolytic solution. In general, aromatic polyimide resins are soluble only in high-boiling organic solvents, for example, cresol. Thus an electrode paste may be prepared by adding a polyamic acid, polyimide precursor which is relatively easily soluble in many organic solvents such as dimethylformamide, dimethylacetamide, N-methylpyrrolidone, ethyl acetate, acetone, methyl ethyl ketone, methyl isobutyl ketone, and dioxolan, and heat treating at a temperature of at least 300° C. for a long time for thereby effecting dehydration and imidization, thus forming a polyimide binder.

Suitable aromatic polyimide resins are those having a basic skeleton derived from tetracarboxylic dianhydrides and diamines. Suitable tetracarboxylic dianhydrides include aromatic tetracarboxylic dianhydrides such as pyromellitic dianhydride, benzophenonetetracarboxylic dianhydride and biphenyltetracarboxylic dianhydride, alicyclic tetracarboxylic dianhydrides such as cyclobutanetetracarboxylic dianhydride, cyclopentanetetracarboxylic dianhydride and cyclohexanetetracarboxylic dianhydride, and aliphatic tetracarboxylic dianhydrides such as butanetetracarboxylic dianhydride, alone or in admixture.

Suitable diamines include aromatic, alicyclic and aliphatic diamines such as, for example, p-phenylene diamine, m-phenylene diamine, 4,4′-diaminodiphenylmethane, 4,4′-diaminodiphenyl ether, 2,2′-diaminodiphenylpropane, 4,4′-diaminodiphenyl sulfone, 4,4′-diaminobenzophenone, 2,3-diaminonaphthalene, 1,3-bis(4-aminophenoxy)benzene, 1,4-bis(4-aminophenoxy)benzene, 4,4′-di(4-aminophenoxy)diphenyl sulfone, 2,2′-bis[4-(4-aminophenoxy)phenyl]propane, alone or in admixture.

Synthesis of polyamic acid intermediate is generally carried out by a solution polymerization process. The process uses a solvent such as N,N′-dimethylformamide, N,N′-dimethylacetamide, N-methyl-2-pyrrolidone, N-methylcaprolactam, dimethyl sulfoxide, tetramethyl urea, pyridine, dimethyl sulfone, hexamethylphosphoramide, and butyrolactone, alone or in admixture.

The reaction temperature is generally in the range of −20° C. to 150° C., and preferably −5° C. to 100° C. The polyamic acid intermediate is converted into a polyimide resin typically by heating to induce dehydration and cyclization. Heating for dehydration and cyclization may be at any temperature in the range of 140 to 400° C. and preferably 150 to 250° C. An appropriate time taken for dehydration and cyclization is 30 seconds to 10 hours, and preferably 5 minutes to 5 hours, depending on the heating temperature.

As the polyimide resin, polyimide resins in powder form and solutions of polyimide precursors in N-methylpyrrolidone are commercially available. Examples include U-Varnish A, U-Varnish S, UIP-R and UIP-S from Ube Industries Ltd., Kayaflex KPI-121 from Nippon Kayaku Co., Ltd., and Rikacoat SN-20, PN-20 and EN-20 from New Japan Chemical Co., Ltd.

In the negative electrode material, the polycrystalline silicon particles are preferably present in an amount of 60 to 97% by weight, and more preferably 70 to 95% by weight. The binder is preferably present in an amount of 3 to 20%, and more preferably 5 to 15% by weight based on the negative electrode material. Less amounts of the binder may allow the active material to separate apart whereas excessive amounts may reduce the percent voids and increase a dielectric fraction to inhibit migration of lithium ions.

When a negative electrode material is prepared using the neutron-irradiated polycrystalline silicon particles as the active material and a polyimide resin as the binder, a conductive agent such as graphite may be added. The type of conductive agent used herein is not particularly limited as long as it is an electronically conductive material which does not undergo decomposition or alteration in the battery. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins. The conductive agent is preferably used in solvent dispersion form because an electrode paste in which the conductive agent is uniformly distributed and bonded to silicon particles is obtained by previously dispersing the conductive agent in a solvent such as water or N-methyl-2-pyrrolidone and adding the dispersion to the active material. Any well-known surfactant may be added to help disperse the conductive agent in the solvent. The solvent used for conductive agent dispersion is desirably the same as the solvent used for the binder.

The conductive agent is preferably present in an amount of 0 to 37% by weight based on the negative electrode material. The amount of conductive agent is more preferably 1 to 20%, and even more preferably 2 to 10% by weight based on the negative electrode material. If the amount of the conductive agent is too small, the negative electrode material may have a poor conductivity, tending to exhibit a higher initial resistivity. An excessive amount of the conductive agent may lead to a loss of battery capacity.

Besides the polyimide resin binder, carboxymethyl cellulose, sodium polyacrylate, acrylic polymers or fatty acid esters may be added as a viscosity regulator to the paste.

From the negative electrode material of the invention, a negative electrode may be prepared, for example, as a shaped form by the following method. The negative electrode active material, a conductive agent, a binder and other additives are kneaded in a solvent (suitable to dissolve and disperse the binder) such as N-methylpyrrolidone or water to form a paste mix, which is applied to a sheet as a current collector. The current collector used herein may be of any materials commonly used as the negative electrode current collector such as copper and nickel foils while it is not particularly limited in thickness and surface treatment. The technique of shaping the mix into a sheet is not particularly limited and any well-known techniques may be used.

Using the negative electrode shaped form, a non-aqueous electrolyte secondary battery may be constructed. The non-aqueous electrolyte secondary battery is characterized by the use of the negative electrode active material defined above while the materials of the positive electrode, separator, electrolytic solution, and electrolyte and the battery design are not particularly limited.

The positive electrode active materials include oxides and sulfides which are capable of occluding and releasing lithium ions. They may be used alone or in admixture. Examples include sulfides and oxides of metals excluding lithium such as TiS₂. MoS₂, NbS₂, ZrS₂, VS₂, V₂O₅, MoO₃, Mg(V₃O₈)₂, and lithium and lithium-containing complex oxides. Composite metals such as NbSe₂ are also useful. For increasing the energy density, lithium complex oxides based on LiₚMetO₂ are preferred wherein Met is preferably at least one element of cobalt, nickel, iron and manganese and p has a of the lithium complex oxides include LiCoO₂, LiNiO₂, LiFeO₂, and Li_{q}NiᵣCo₁₋ᵣO₂ (wherein q and r have values varying with the charged/discharged state of the battery and usually in the range: 0<q<1 and 0.7<r≦1) having a layer structure, LiMn₂O₄ having a spinel structure, and rhombic LiMnO₂. Also used is a substitutional spinel type manganese compound adapted for high voltage operation which is LiMetₛMn₁₋ₛO₄ wherein Met is titanium, chromium, iron, cobalt, nickel, copper, zinc or the like and s has a value in the range: 0<s<1.

It is noted that the lithium complex oxide described above is prepared, for example, by grinding and mixing a carbonate, nitrate, oxide or hydroxide of lithium and a carbonate, nitrate, oxide or hydroxide of a transition metal in accordance with the desired composition, and firing at a temperature in the range of 600 to 1,000° C. in an oxygen atmosphere.

Organic materials may also be used as the positive electrode active material. Examples include polyacetylene, polypyrrole, poly-p-phenylene, polyaniline, polythiophene, polyacene, and polysulfide.

From the positive electrode active material, a positive electrode (shaped form) may be prepared by a well-known method, specifically by mixing the active material with a conductive agent and a binder (as used in the negative electrode mix) and applying the mix to a current collector.

The separator disposed between the positive and negative electrodes is not particularly limited as long as it is stable to the electrolytic solution and holds the solution effectively. The separator is most often a porous sheet or non-woven fabric of polyolefins such as polyethylene, polypropylene and copolymers thereof and aramide resins. Such sheets may be used as a single layer or a laminate of multiple layers. Ceramics such as metal oxides may be deposited on the surface of sheets. Porous glass and ceramics are employed as well.

The non-aqueous solvent used herein is not particularly limited as long as it can serve for the non-aqueous electrolytic solution. Suitable solvents include aprotic high-dielectric-constant solvents such as ethylene carbonate, propylene carbonate, butylene carbonate, and γ-butyrolactone; and aprotic low-viscosity solvents such as dimethyl carbonate, ethyl methyl carbonate, diethyl carbonate, methyl propyl carbonate, dipropyl carbonate, diethyl ether, tetrahydrofuran, 1,2-dimethoxyethane, 1,2-diethoxyethane, 1,3-dioxolan, sulfolane, methylsulfolane, acetonitrile, propionitrile, anisole, acetic acid esters, e.g., methyl acetate and propionic acid esters. It is desirable to use a mixture of an aprotic high-dielectric-constant solvent and an aprotic low-viscosity solvent in a proper ratio. It is also acceptable to use ionic liquids containing imidazolium, ammonium and pyridinium cations. The counter anions are not particularly limited and include BF₄⁻, PF₆⁻ and (CF₃SO₂)₂N⁻. The ionic liquid may be used in admixture with the foregoing non-aqueous solvent.

Where a solid or gel electrolyte is desired, a silicone gel, silicone polyether gel, acrylic gel, silicone-acrylic gel, acrylonitrile gel, poly(vinylidene fluoride) or the like may be included in a polymer form. These ingredients may be polymerized prior to or after casting. They may be used alone or in admixture.

Exemplary of the electrolyte salt used herein are light metal salts. Examples of the light metal salts include salts of alkali metals such as lithium, sodium and potassium, salts of alkaline earth metals such as magnesium and calcium, and aluminum salts. A choice may be made among these salts and mixtures thereof depending on a particular purpose. Examples of suitable lithium salts include LiBF₄, LiClO₄, LiPF₆, LiAsF₆, CF₃SO₃Li, (CF₃SO₂)₂NLi, C₄F₉SO₃Li, CF₃CO₂Li, (CF₃CO₂)₃NLi, C₆F₅SO₃Li, C₈F₁₇SO₃Li, (C₂F₅SO₂)₂NLi, (C₄F₉SO₂)(CF₃SO₂)NLi, (FSO₂C₆F₄)(CF₃SO₂)NLi, ((CF₃)₂CHOSO₂)₂NLi, (CF₃SO₂)₃CLi, (3,5-(CF₃)₂C₆F₃)₄BLi, LiCF₃, LiAlCl₄, and C₄BO₈Li, which may be used alone or in admixture.

From the conductivity aspect, the electrolyte salt is preferably present in a concentration of 0.5 to 2.0 mole/liter of the non-aqueous electrolytic solution. The electrolyte should preferably have a conductivity of at least 0.01 S/cm at a temperature of 25° C., which may be adjusted in terms of the type and concentration the electrolyte salt.

If desired, various additives may be added to the non-aqueous electrolytic solution. Examples include an additive for improving cycle life such as vinylene carbonate, methyl vinylene carbonate, ethyl vinylene carbonate and 4-vinylethylene carbonate, an additive for preventing over-charging such as biphenyl, alkylbiphenyl, cyclohexylbenzene; t-butylbenzene, diphenyl ether, and benzofuran, and various carbonate compounds, carboxylic acid anhydrides, nitrogen- and sulfur-containing compounds for acid removal and water removal purposes.

The secondary battery may take any desired shape. In general, the battery is of the coin type wherein electrodes and a separator, all punched into coin shape, are stacked, or of the rectangular or cylinder type wherein electrode sheets and a separator are spirally wound.

A further embodiment is an electrochemical capacitor which is characterized by comprising the negative electrode active material described above, while other materials such as electrolyte and separator and capacitor design are not particularly limited.

### EXAMPLE

Examples are given below for further illustrating the invention, but they are not to be construed as limiting the invention thereto. In Examples, all percents (%) are by weight, and the average particle size is a cumulative weight average value or median diameter D₅₀ as determined from particle size distribution measurement by laser light diffractometry. A jet mill AFG-100 is available from Hosokawa Micron Group, and a classifier TC-15 is available from Nisshin Engineering Co., Ltd.

### Preparation of Negative Electrode Active Material #1

A quartz tube was filled with granular polycrystalline silicon (available from MEMC Electronic Materials, Inc.) which had been prepared by introducing polycrystalline silicon fine particles into a fluidized bed at an internal temperature of 800° C. and feeding monosilane thereto. The silicon was irradiated with neutrons at a thermal neutron flux of 9.6×10¹⁷ m⁻²s⁻¹ for 12 hours. After 3 hours from irradiation, the silicon was taken out of the tube and ground in a jet mill AFG-100 with the built-in classifier operating at 7,200 rpm and then classified through a classifier TC-15. There was obtained a polycrystalline silicon powder with D₅₀=10.2 μm. By ICP emission spectrometry, the powder was analyzed to have a P content of 170 ppm. On analysis by the AC impedance method with a scanning range of 1 to 100,000 Hz using an impedance analyzer model 12608W (Solartron), the powder had a resistivity of 50 Ω-cm.

### Preparation of Comparative Negative Electrode Active Material #2

Granular polycrystalline silicon (same as above) was ground in a jet mill AFG-100 with the built-in classifier operating at 7,200 rpm and then classified through a classifier TC-15, obtaining a polycrystalline silicon powder with D₅₀=9.9 μm. The powder had a P content of 0.1 ppm and a resistivity of 3.1 MΩ-cm.

### Preparation of Comparative Negative Electrode Active Material #3

A metallic silicon mass (Elkem AS) was crushed in a jaw crusher, ground in a jet mill AFG-100 with the built-in classifier operating at 7,200 rpm and then classified through a classifier TC-15, obtaining a metallic silicon powder with D₅₀=10.2 μm. The powder had a P content of 35 ppm and a resistivity of 1.2 kΩ-cm.

The particle size D₅₀, P content and resistivity of silicon powders are summarized in Table 1.

TABLE 1

| Negative electrode | D₅₀ | P content | Resistivity |
|---|---|---|---|
| active material | (μm) | (ppm) | (Ω-cm) |
| #1 | 10.2 | 170 | 50 |
| #2 (comparison) | 9.9 | 0.1 | 3.1 × 10⁶ |
| #3 (comparison) | 10.2 | 35 | 1.2 × 10³ |

### Evaluation of Cell Performance

The effectiveness of a negative electrode active material in a lithium ion secondary cell was evaluated by the following test.

To 8.75 parts by weight of the negative electrode active material was added 0.25 part by weight of synthetic graphite with an average particle size D₅₀ of 3 μm. The mixture was combined with 1.4 parts by weight of a dispersion of acetylene black in N-methylpyrrolidone (solids 17.5%) and diluted with 4 parts by weight of N-methylpyrrolidone. The mixture was further combined with 1.6 parts by weight of a polyimide resin as a binder and agitated to form a slurry. The slurry was coated onto a copper foil of 12 μm thick by means of a doctor blade having a gap of 50 Mm, dried at 200° C. for 2 hours, and pressed by a roller press at 60° C. into a negative electrode shaped form. Finally, pieces of 2 cm² were punched out of the shaped form and used as a negative electrode.

To evaluate the rate characteristics of a negative electrode shaped form, a coin-type lithium ion secondary cell was fabricated. The positive electrode was a single layer sheet using LiCoO₂ as the active material and an aluminum foil as the current collector (trade name Pioxcel C-100 by Pionics Co., Ltd.). The non-aqueous electrolyte was a non-aqueous electrolyte solution of lithium hexafluorophosphate in a 1/1 (by volume) mixture of ethylene carbonate and diethyl carbonate in a concentration of 1 mol/liter. The separator was a porous polyethylene film of 30 μm thick.

The cell was aged two nights at room temperature before it was tested by means of a secondary cell charge/discharge tester (Nagano K. K.). Charging was conducted with a constant current flow of 1.2 mA (0.25 C vs. positive electrode) until the voltage of the test cell reached 4.2 V, and after reaching 4.2 V, continued with a reduced current flow so that the cell voltage was kept at 4.2 V, and terminated when the current flow decreased below 0.3 mA. Discharging was conducted at rates 0.2 C and 1.0 C. The discharge capacity at 1.0 C discharging divided by discharge capacity at 0.2 C discharging represents a rate factor (%). The results are shown in Table 2. The lithium ion secondary cell using comparative negative electrode active material #2 with a low P content is inferior in rate characteristics.

To evaluate the cycle performance of a negative electrode shaped form, a similar coin-type lithium ion secondary cell was fabricated. Charging was conducted with a constant current flow of 1.2 mA (0.25 C vs. positive electrode) until the voltage of the test cell reached 4.2 V, and after reaching 4.2 V, continued with a reduced current flow so that the cell voltage was kept at 4.2 V, and terminated when the current flow decreased below 0.3 mA. Discharging was conducted with a constant current flow of 0.6 mA and terminated when the cell voltage reached 2.5 V. A discharge capacity was determined. The charging/discharging operation was repeated 200 cycles. The results are also shown in Table 2. The lithium ion secondary cell using comparative negative electrode active material #3 which is metallic silicon is inferior in cycle performance.

TABLE 2

| | | Capacity retentivity |
|---|---|---|
| Negative electrode | 1.0 C/0.2 C | after 200 cycles |
| active material | (%) | (%) |
| #1 | 96.1 | 61 |
| #2 (comparison) | 88.4 | 57 |
| #3 (comparison) | 95.6 | 46 |

Japanese Patent Application No. 2008-162973 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A negative electrode material for non-aqueous electrolyte secondary batteries, comprising silicon particles wherein ³⁰Si in silicon has been transformed to ³¹P through nuclear reaction by neutron irradiation.

2. The negative electrode material of claim 1 wherein said silicon is polycrystalline silicon.

3. The negative electrode material of claim 1 comprising 60 to 97% by weight of polycrystalline silicon particles, 3 to 20% by weight of a binder, and 0 to 37% by weight of a conductive agent.

4. The negative electrode material of claim 1 wherein said silicon particles contain 1 to 100,000 ppm of phosphorus.

5. The negative electrode material of claim 1 wherein a powder of said silicon particles has a resistivity of up to 100 kΩ-cm.

6. A negative electrode for non-aqueous electrolyte secondary batteries, comprising the negative electrode material of claim 1.

7. A non-aqueous electrolyte secondary battery comprising a negative electrode shaped form comprising the negative electrode of claim 6, a positive electrode shaped form, a separator, and a non-aqueous electrolyte.

8. The non-aqueous electrolyte secondary battery of claim 7 which is a lithium ion secondary battery.

9. An electrochemical capacitor comprising a negative electrode shaped form comprising the negative electrode of claim 6, a positive electrode shaped form, a separator, and a non-aqueous electrolyte.
